(19) United States
(12) Patent Application Publication
(10) Pub. No.: US 2013/0100392 A1
(43) Pub. Date: Apr. 25, 2013

(54) FLEXIBLE DISPLAY DEVICE AND METHOD FOR MANUFACTURING FLEXIBLE DISPLAY DEVICE

(71) Applicant: Yasumori Fukushima, Osaka-shi (JP)

(72) Inventor: Yasumori Fukushima, Osaka-shi (JP)

(73) Assignee: Sharp Kabushiki Kaisha, Osaka-shi (JP)

(21) Appl. No.: 13/807,040

(22) PCT Filed: Jun. 24, 2011
(86) PCT No.: PCT/JP2011/064529

§ 371 Date: Dec. 27, 2012

(30) Foreign Application Priority Data
Jun. 29, 2010 (JP) 2010-148227

(51) Int. Cl. G02F 1/133; G02F 1/1333

(52) U.S. Cl. CPC G02F 1/13306; G02F 1/1333
USPC 349/150; 445/24

(57) ABSTRACT

A flexible display device (100) according to the present invention includes a display panel (10), a circuit board (30), a circuit part (32), and a housing (20). The display panel, the circuit board, and the housing have flexibility at least along a first direction which is perpendicular to the plane of the display panel. A length 2a of the circuit part along a second direction which is parallel to the plane of the display panel, a thickness b of the circuit part along the first direction, a distance d between the bottom face and the upper face of the housing or between the bottom face of the housing and a lower face of the display panel, and a radius of curvature r of the bottom face of the housing when the housing is curved to a maximum extent along the first direction satisfy the relationship a≦[d²−b²+2·r·(d−b)]^{(1/2)}. According to the present invention, a highly flexible electronic device or display device can be provided by using circuit parts of appropriate sizes, without unnecessarily increasing the device thickness.

### TECHNICAL FIELD

The present invention relates to an electronic device having flexibility (flexible electronic device), or a display device having flexibility which is for use in e.g. an electronic book, an electronic notebook, an electronic newspaper, digital signage, or the like.

### BACKGROUND ART

A wide variety of electronic devices and display devices have hitherto been developed, among which is a flexible electronic device having a display section, such as that described in Patent Document 1. This electronic device is illustrated as a highly flexible electronic device that includes a display panel having flexibility, a substrate having flexibility, a battery having flexibility, and so on.

With reference to FIG. 11 and FIG. 12, the construction of the electronic device of Patent Document 1 will be described.

FIG. 11(a) is a plan view showing the construction of a flexible electronic device 200 which is described in Patent Document 1 as an electronic device of a first example construction. FIG. 11(b) is a cross-sectional view showing the construction of the flexible electronic device 200 through a flexible display panel 212.

As shown in FIGS. 11(a) and (b), the flexible electronic device 200 includes a flexible display panel 212 having a flexible driver IC 211 for driving, a flexible printed circuit 213, a flexible driving circuit board 214 (hereinafter simply referred to as the “substrate 214”), a flexible case 216 (hereinafter simply referred to as the “case 216”), and a flexible battery 217.

FIG. 12 is a plan view showing the construction of the substrate 214 of Patent Document 1. As shown in FIG. 12, a plurality of rigid circuit parts 232 are disposed in a matrix shape on the substrate 214. In a portion of the substrate 214 where no circuit parts 232 are disposed, a plurality of lines of bending f extend linearly, such that the substrate 214 is bendable at the lines f of bending.

Thus, since many of its constituent elements have flexibility, the flexible electronic device 200 is supposed to have a high flexibility across the entire device. Furthermore, although each of the plurality of circuit parts 232 disposed on the substrate 214 lacks flexibility, the plurality of circuit parts 232 are disposed in a matrix shape, thus allowing the plurality of lines f of bending to extend across the entire substrate, thereby further promoting flexibility.

### CITATION LIST

### Patent Literature

[Patent Document 1] Japanese Laid-Open Patent Publication No. 2008-233779

### SUMMARY OF INVENTION

### Technical Problem

The flexible electronic device 200 of Patent Document 1 can be flexed at the positions of the lines f of bending (i.e., any portion called the “sea” in Patent Document 1); however, in the portions surrounded by the lines f of bending (i.e., portions called the “islands”), the rigid circuit parts 232 hinder sufficient flexibility. Patent Document 1 fails to describe any specific construction and designing scheme for allowing the substrate or the like to be flexed or curved at portions other than the lines f of bending. Moreover, Patent Document 1 lacks discussion of any relationship between the level of flexibility required of the flexible electronic device 200 and the thickness of the case 216, the width of the circuit parts 232, and the thickness of the circuit parts 232, thus making it difficult to realize a flexibility that is optimum for an appliance.

For example, given the same circuit parts 232, flexibility will presumably improve if the thickness of the case 216 is increased. Also presumably, given a constant thickness of the case 216, flexibility will improve if the width and thickness of the circuit parts 232 are reduced. However, increasing the thickness of the case 216 will increase the thickness of the entire appliance, thus resulting in a problem of difficulty of downsizing the appliance. Moreover, it is often difficult to change the sizes of the necessary circuit parts 232, and it is not easy to improve the flexibility of the appliance based on the sizes of the circuit parts 232. Since the limits of flexibility of an appliance are determined by the dimensions of each individual rigid circuit part 232, it is impossible according to principles to improve the flexibility while keeping a constant thickness of the case 216, even if the circuit parts 232 are disposed in island shapes or in a matrix shape.

The present invention has been made in view of the above problems, and an objective thereof is to provide a highly flexible electronic device or display device by using circuit parts of appropriate sizes, without unnecessarily increasing the device thickness. Another objective of the present invention is to provide an electronic device or display device which reconciles thinness and flexibility with a good balance.

### Solution to Problem

A display device according to the present invention comprises: a display panel having flexibility; a circuit board having flexibility; a circuit part disposed on the circuit board, the circuit part having rigidity; and a housing accommodating the circuit board and supporting the display panel above the circuit board, the housing having flexibility, wherein, the display panel, the circuit board, and the housing have flexibility at least along a first direction which is perpendicular to the plane of the display panel; the housing internally has an upper face and a bottom face, the circuit board being disposed on the bottom face of the housing; and a length 2a of the circuit part along a second direction which is parallel to the plane of the display panel, a thickness b of the circuit part along the first direction, a distance d between the bottom face and the upper face of the housing or between the bottom face and a lower face of the display panel, and a radius of curvature r of the bottom face of the housing when the housing is curved to a maximum extent along the first direction satisfy the relationship:

a≦[d²−b²+2·r·(d−b)]^{(1/2)}.

In one embodiment, the radius of curvature r is a radius of curvature of the bottom face of the housing when the housing is curved so that the upper face of the housing or the lower face of the display panel abuts with the circuit part.

In one embodiment, the distance d is in a range greater than 0.5 mm but smaller than 10 mm, and the radius of curvature r is in a range greater than 1 mm but smaller than 200 mm.

In one embodiment, the distance d is in a range greater than 1 mm but smaller than 3 mm, and the radius of curvature r is in a range greater than 5 mm but smaller than 60 mm.

In one embodiment, the radius of curvature r is a radius of curvature of the bottom face at the position of the circuit part when the housing at the circuit part of the position is curved to a maximum extent along the first direction.

In one embodiment, the distance d is in a range greater than 0.5 mm but smaller than 3 mm, and the radius of curvature r is in a range greater than 1 mm but smaller than 30 mm.

In one embodiment, the circuit part is a semiconductor chip, a semiconductor circuit board, a resistor, or a capacitor.

In one embodiment, the circuit board is a flexible printed board whose main component is polyimide.

In one embodiment, the display panel includes a pair of flexible substrates at least one of which is transparent, and liquid crystal sealed between the pair of flexible substrates, and performs displaying by altering an optical characteristic of the liquid crystal by applying an electric field across the liquid crystal.

One embodiment comprises within the housing a battery for supplying power to the circuit part.

In one embodiment, the battery has flexibility.

A production method of a flexible display device according to the present invention comprises: a step of providing a circuit part having rigidity, a housing internally having an upper face and a bottom face, and a display panel; a step of disposing the circuit part on a circuit board; a step of disposing the circuit board on the bottom face of the housing; and a step of disposing the display panel on the housing, wherein, the display panel, the circuit board, and the housing have flexibility at least along a first direction which is perpendicular to the plane of the display panel; and in the step of providing the circuit part, the housing, and the display panel, given a length 2a of the circuit part along a second direction which is parallel to the plane of the display panel, a thickness b of the circuit part along the first direction, a distance d between the bottom face and the upper face of the housing or between the bottom face and a lower face of the display panel, and a minimum radius of curvature r of the bottom face of the housing determined when the housing is curved along the first direction, the circuit part and the housing are selected in sizes satisfying the relationship:

a≦[d²−b²+2·r·(d−b)]^{(1/2)}.

In one embodiment, the radius of curvature r is a radius of curvature of the bottom face when the housing is curved so that the upper face of the housing or the lower face of the display panel abuts with the circuit part.

In one embodiment, when the radius of curvature r is in a range greater than 1 mm but smaller than 200 mm, in the step of providing the circuit part, the housing, and the display panel, a housing is provided such that the distance d is in a range greater than 0.5 mm but smaller than 10 mm.

In one embodiment, when the radius of curvature r is in a range greater than 5 mm but smaller than 60 mm, in the step of providing the circuit part, the housing, and the display panel, a housing is provided such that the distance d is in a range greater than 1 mm but smaller than 3 mm.

In one embodiment, the radius of curvature r is a radius of curvature which is required of the bottom face at the position of the circuit part when the housing at the position of the circuit part is curved to a maximum extent along the first direction.

In one embodiment, when the radius of curvature r is in a range greater than 1 mm but smaller than 30 mm, the distance d is set in a range greater than 0.5 mm but smaller than 3 mm.

In one embodiment, the circuit part is a semiconductor chip, a semiconductor circuit board, a resistor, or a capacitor.

In one embodiment, the display panel includes a pair of flexible substrates at least one of which is transparent, and liquid crystal sealed between the pair of flexible substrates, and performs displaying by altering an optical characteristic of the liquid crystal by applying an electric field across the liquid crystal.

### Advantageous Effects of Invention

According to the present invention, it is possible to provide a highly flexible electronic device or display device by using circuit parts of appropriate sizes, without unnecessarily increasing the device thickness. Also according to the present invention, it is possible to provide an electronic device or display device which reconciles thinness and flexibility with a good balance.

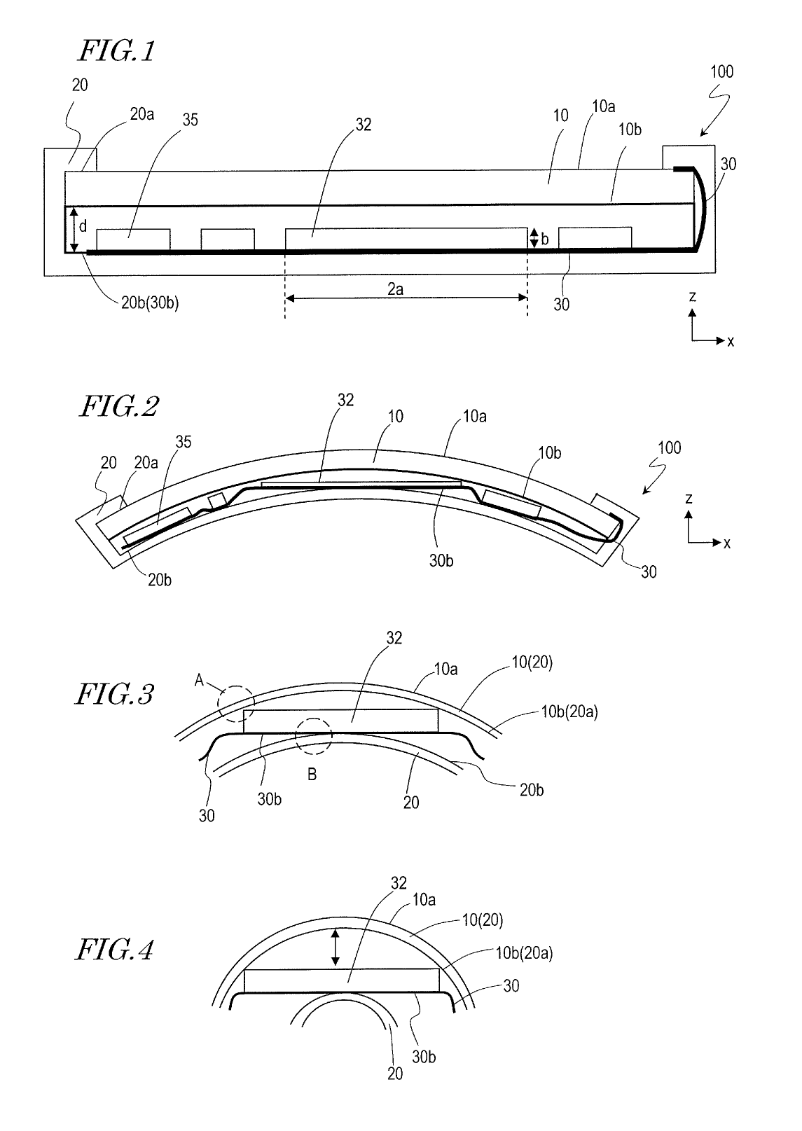

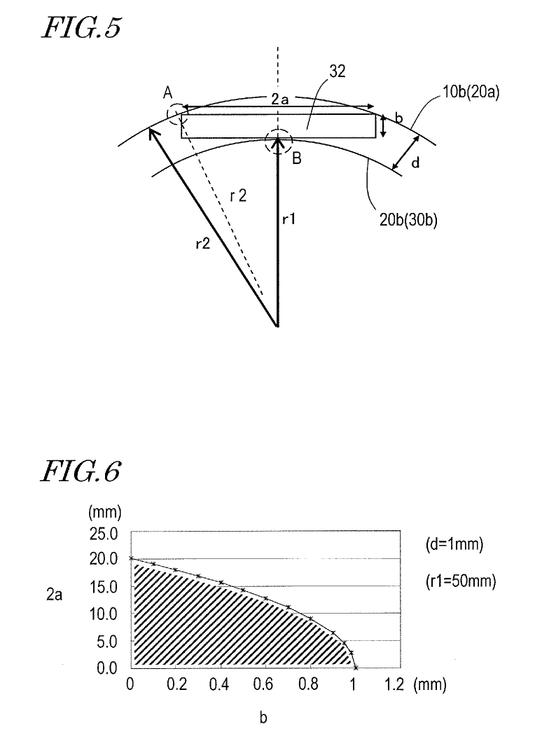

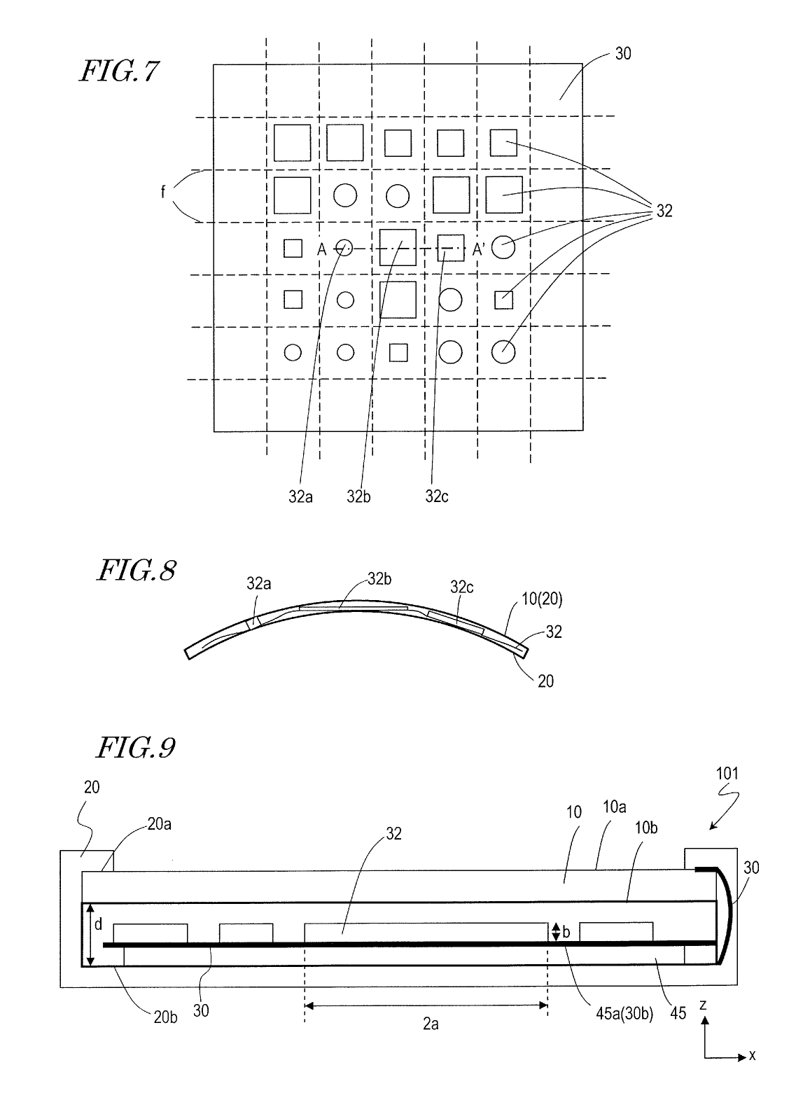

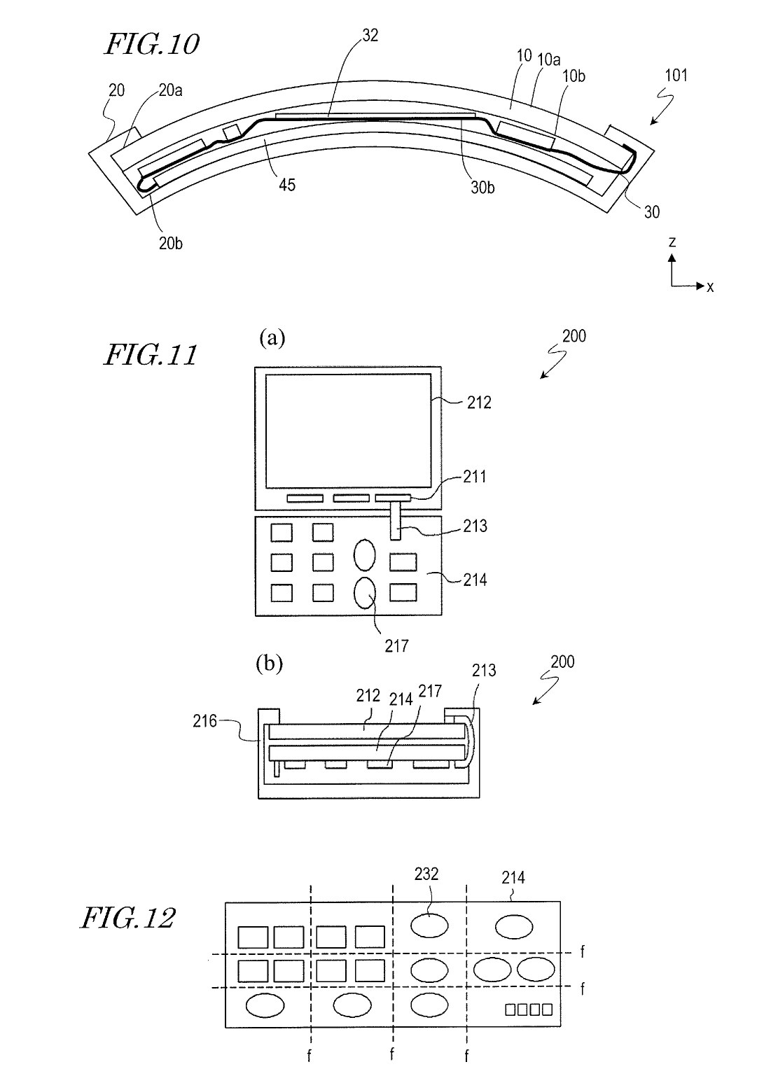

### BRIEF DESCRIPTION OF DRAWINGS

[FIG. 1] A cross-sectional view schematically showing the construction of a display device 100 according to Embodiment 1 of the present invention.

[FIG. 2] A cross-sectional view showing a manner in which the display device 100 may be curved.

[FIG. 3] A cross-sectional view schematically showing a portion of the curved display device 100.

[FIG. 4] A cross-sectional view showing a manner in which a display device 100 having a housing 20 with a greater thickness than that shown in FIG. 3 may be curved.

[FIG. 5] A cross-sectional view showing, in the display device 100 under a curved state, a relationship between the sizes of a housing 20 and a circuit part 32 and a radius of curvature of the housing 20.

[FIG. 6] A graph showing a relationship between the length 2a and the thickness b of a circuit part 32 obtained according to the present invention, given a radius of curvature r1 of 50 mm and given that the internal space of the housing 20 has a thickness d of 1 mm.

[FIG. 7] A plan view schematically showing the construction of a circuit board 30 in which a plurality of circuit parts 32 are disposed in a matrix shape.

[FIG. 8] A diagram schematically showing a cross section of the display device 100 at position A-A′ in FIG. 7.

[FIG. 9] A cross-sectional view schematically showing the construction of a display device 101 according to Embodiment 2 of the present invention.

[FIG. 10] A cross-sectional view showing a manner in which the display device 101 may be curved.

[FIG. 11] (a) is a plan view showing the construction of a flexible electronic device 200 which is described in Patent Document 1 as an electronic device of a first example construction; and (b) is a cross-sectional view showing the construction of the flexible electronic device 200 through a flexible display panel 212.

[FIG. 12] A plan view showing the construction of a substrate 214 according to Patent Document 1.

### DESCRIPTION OF EMBODIMENTS

Hereinafter, with reference to the drawings, display devices according to embodiments of the present invention will be described. However, the scope of the present invention is not limited to the following embodiments.

### Embodiment 1

FIG. 1 is a cross-sectional view schematically showing the construction of a display device 100 according to Embodiment 1, and FIG. 2 is a cross-sectional view schematically showing a manner in which the display device 100 may be curved.

The display device 100 is a display device having flexibility, and as shown in FIG. 1 and FIG. 2, includes: a display panel 10 having flexibility; a housing 20 having flexibility; a circuit board 30 composed of a flexible printed board (FPC) or the like having flexibility; and a (rigid) circuit part 32 being disposed on the circuit board 30 and having rigidity. Furthermore, the display device 100 includes a battery 35 for supplying power to the circuit part 32, the battery 35 being disposed on the circuit board 30. The housing 20 accommodates the circuit board 30, and supports the display panel 10 being disposed above the circuit board 30 and the battery 35.

The display panel 10, the housing 20, and the circuit board 30 have flexibility at least along a Z direction (first direction) which is perpendicular to the plane (an upper face 10a or a lower face 10b) of the display panel 10. The housing 20 internally has an upper face 20a and a bottom face 20b, the circuit board 30 being disposed on the bottom face 20b of the housing 20. The display panel 10 is disposed so that the upper face 10a thereof is in contact with the upper face 20a of the housing 20.

Assuming a length 2a of the circuit part 32 along an X direction (second direction) which is parallel to the plane of the display panel 10, a thickness b (length along the Z direction) of the circuit part 32, a distance d between the bottom face 20b of the housing 20 (or the lower face 30b of the circuit board 30) and the lower face 10b of the display panel 10 (distance along the Z direction), and a radius of curvature r of the bottom face 20b of the housing 20 when the housing 20 is curved to a maximum extent along the Z direction, these values satisfy the following relationship.

a≦[d²−b²+2·r·(d−b)]^{(1/2)} (1)

Note that, in any portion of the display device 100 where the display panel 10 is not disposed, the upper part of the housing 20 is located at where the display panel 10 would be; therefore, in such portions, d represents the distance between the bottom face 20b of the housing 20 and the upper face 20a of the housing 20.

The radius of curvature r is a radius of curvature of the bottom face 20b of the housing 20 when the housing 20 is curved so that the upper face 20a of the housing 20 or the lower face 10b of the display panel 10 abuts with the circuit part 32. Note that, when the housing 20 is curved as shown in FIG. 2, the radius of curvature r is to be defined within a plane which is parallel to the X direction and the Z direction.

The circuit part 32 is an electronic part, e.g., a semiconductor chip, a semiconductor circuit board, a resistor, or a capacitor; and the circuit board 30 is a flexible printed board whose main component is polyimide. Although omitted from illustration, the display panel 10 includes a pair of flexible substrates, at least one of which is transparent, and liquid crystal sealed between the pair of flexible substrates, and performs displaying by altering the optical characteristics of the liquid crystal by applying an electric field across the liquid crystal. Note that, without being limited to a liquid crystal display panel, this display panel may be any other type of display device, e.g., an organic EL display device, or an electrophoretic type display device. As the battery 35, not only a lithium battery, but also a laminated battery or a paper battery such as that of lithium ion polymer may be used.

FIG. 3 is a cross-sectional view schematically showing a portion of the curved display device 100.

In the aforementioned structure where the rigid circuit part 32 is included in the housing 20 having flexibility, the inventors of the present invention have studied the manner in which curvature may be determined when the housing 20 (or the display device 100) is bent to a maximum extent, thus arriving at the following concept.

As the housing 20 is bent to increasing extents, at some point, as indicated by a portion B in FIG. 3, the lower part of the rigid circuit part 32 will come in contact with the bottom face 20b of the housing 20; and as indicated by portion A, an end of the upper face of the circuit part 32 will come in contact with the lower face 10b of the overlying display panel (or the upper face 20a of the housing 20). This state defines the maximum degree to which the housing 20 can be bent, and is considered as a state representing the maximum curvature (minimum radius of curvature) of the housing 20 (or the display device 100). If the housing 20 were to be bent any more, the rigid circuit part 32 would come in contact with the housing 20, thus restraining the housing 20 from curving. Therefore, according to principles, the housing 20 can no longer be curved; if it were forcibly bent, stress would apply to both the circuit part 32 and the housing 20, possibly destroying them.

FIG. 4 is a cross-sectional view showing a manner in which the display device 100 having a housing 20 with a greater thickness than that shown in FIG. 3 may be curved.

As shown in FIG. 4, increasing the thickness or the internal gap width d of the housing 20 will allow the housing 20 to bend to a greater extent. In this case, however, the size of the display device 100 will also increase as the housing 20 becomes thicker, which is not preferable.

From the above study, we have arrived at the belief that, since the limits of flexibility of the housing 20 are determined by the dimensions of each individual rigid circuit part 32, it is impossible according to principles to improve the flexibility while keeping a constant thickness of the housing 20, even if the circuit parts 32 are disposed in island shapes or in a matrix shape.

The inventors of the present invention have further conducted a detailed study as follows.

FIG. 5 is a cross-sectional view showing, in the display device 100 under a curved state, a relationship between the sizes of the housing 20 and the circuit part 32 and a radius of curvature of the housing 20.

As described above, assuming a length 2a of the circuit part 32 along the X direction, a thickness b of the circuit part 32, a distance d (thickness of the internal space of the housing 20) between the bottom face 20b of the housing 20 (or the lower face 30b of the circuit board 30) and the lower face 10b of the display panel 10 (or the upper face 20a of the housing 20), a radius of curvature of the bottom face 20b of the housing 20 when the housing 20 is curved to a maximum extent along the Z direction is defined as r₁ (=r). When the radius of curvature is r₁, the upper corners of the circuit part 32 just abut with the lower face of the display panel 10 (or the upper face of the housing 20), and the lower central portion of the circuit part 32 abuts with the bottom face 20b of the housing 20 (or the lower face 30b of the circuit board 30). This state, illustrated in FIG. 5, is considered as a limit state up to which the housing 20 is bendable without increasing the thickness of the housing 20 or the display device 100.

At this time, defining a radius of curvature r₂ of the upper face 20a of the housing 20 (or the lower face 10b of the display panel 10), the following relationship holds (in the figure, the Pythagorean Theorem is applied with reference to auxiliary lines indicated as dotted lines).

r₂²=(r₁+b)²+a²

r₂=r₁+d

By erasing r₂ and rearranging the two equations, the following equation is obtained.

a≦[d²−b²+2·r₁(d−b)]^{(1/2)} (2)

Once the thickness d of the internal space of the housing 20, the thickness b of the circuit part 32, and the minimum radius of curvature r₁ of the bottom face 20b of the housing 20 (the radius of curvature r₁ when the housing 20 is bent to a maximum extent) are decided, then the maximum length 2a of the circuit part 32 will be determined from this equation. Therefore, by setting a tolerable length 2a and thickness b of the circuit part 32 within ranges where the above equation are satisfied given the desired thickness d of the internal space of the housing 20 and the required radius of curvature r₁ a desired thin and flexibility can be realized. In other words, by setting 2a and b so as to satisfy

a≦[d²−b²+2·r₁(d−b)]^{(1/2)} (1),

it becomes possible to reconcile thinness and flexibility of the housing 20 and the display device 100. Conventional art, such as Patent Document 1, fails to disclose or suggest designing or producing the display device 100 while thus taking into consideration the relationship between the sizes of the components of the display device 100 and the radius of curvature r in order to reconcile thinness and flexibility.

In determining the sizes of the housing 20 and the circuit part 32, if the required minimum radius of curvature r(r₁) is set in a range greater than 1 mm but smaller than 200 mm (from a state where the housing 20 is essentially folded (r=1 mm) to a state where the housing 20 is slightly but definitely bent (r=200 mm)), it is preferable that the thickness d of the internal space of the housing 20 is in a range greater than 0.5 mm but smaller than 10 mm. This allows a display device 100 that is formed so as to fit within a range from a thickness which will be considered as the thinnest (internal space thickness d=0.5 mm) to a thickness which will be considered as relatively thin (internal space thickness d=10 mm) by the user to be bent to the required minimum radius of curvature r.

In determining the sizes of the housing 20 and the circuit part 32, if the required minimum radius of curvature r is set in a range greater than 5 mm but smaller than 60 mm (from a state as if the housing 20 is bent around a human finger (r=5 mm) to a curvature up to which the housing 20 is guaranteed for IC cards or the like (r=60 mm)), it is preferable that the thickness d of the internal space of the housing 20 is in a range greater than 1 mm but smaller than 3 mm. This allows a display device 100 that is formed with a thickness which is relatively easily producible and which will be considered by the user as sufficiently thin (internal thickness d=1 to 3 mm) to be bent to the required minimum radius of curvature r.

Furthermore, the radius of curvature r may be defined as the radius of curvature of the bottom face 20b in an “island” portion when the housing 20 at the position of the circuit part 32 (“island” portion, including the subsequently-described circuit part 32 surrounded by a plurality of lines f of bending) is curved to a maximum extent along the Z direction, or the minimum radius of curvature that is designated for the display device 100. In this case, it is preferable that the distance d is in a range greater than 0.5 mm but smaller than 3 mm, and that the radius of curvature r is in a range greater than 1 mm but smaller than 30 mm. By selecting a distance d and a radius of curvature r in such ranges, it becomes possible to further enhance the flexibility of the entire device, including the “island” portion containing the rigid circuit part 32. As a result, an appropriate flexibility which is adapted to the device size can be obtained, and the display device 100 made thinner can have a further enhanced flexibility.

According to the above-described embodiment, a flexible thin display device and thin electronic device with a reduced thickness, a reduced radius of curvature, and uniform flexibility (bending smoothly) across the entire device can be realized. The display device and electronic device according to the present invention can prevent local bending, so that the stress of bending is prevented from localizing in specific portions of the housing, thus enhancing the reliability of the device. Moreover, since the device housing bends smoothly, an electronic device with excellent design aesthetic can be realized, and a more natural and human-friendly impression can be evoked in the user.

FIG. 6 is a graph showing a relationship between the length 2a and the thickness b of the circuit part 32 obtained according to eq. (1) above, given a radius of curvature r1 of 50 mm and given that the thickness d of the internal space of the housing 20 is 1 mm. In this graph, the vertical axis represents the length 2a of the circuit part 32, and the horizontal axis represents the thickness b of the circuit part 32.

A hatched portion in the graph of FIG. 6 indicates combinations of 2a and b that satisfy the above inequality (1) when the radius of curvature r1 is 50 mm and the thickness d of the internal space of the housing 20 is 1 mm. Therefore, by using any combination of 2a and b in the hatched portion of FIG. 6, it becomes possible to realize a desired flexibility in a display device 100 that satisfies the above conditions (radius of curvature r1: 50 mm, internal thickness of the housing 20: 1 mm).

Therefore, the same flexibility can be attained either in a circuit part 32 with an increased thickness b and a reduced length 2a, or in a circuit part 32 with a minimized thickness b and an increased length 2a, so long as a combination within the range indicated by the hatched portion in FIG. 6 is used.

In the display device 100 of the present embodiment, circuit parts of various shapes can be disposed in a matrix shape so long as eq. (1) above is satisfied. This means a great freedom with which the thickness and size of circuit parts 32 to be mounted on the circuit board 30, e.g., semiconductor chips, resistors, capacitors, or inductors, are selected according to the parts. This makes it possible to choose part dimensions which are suited for the structure or production method of the circuit parts 32.

In the case where a semiconductor circuit chip is used as a circuit part 32, the semiconductor circuit chip needs to be cut out from a semiconductor substrate through dicing or the like. The portions at which the semiconductor circuit is cut out are called street lines, which usually necessitate a width of about 50 to 100 μm. A decrease in the size of the semiconductor circuit chip results in an increase in the proportion which the street line width accounts for in the semiconductor substrate. This detracts from the effective area from which the semiconductor circuit chips are to be obtained, thus boosting the unit price of the semiconductor circuit chip per unit area. Therefore, it is desirable to select as large semiconductor circuit chip dimensions as possible, while satisfying the above relational expression (1).

A plurality of circuit parts 32 may be disposed in a matrix shape on the circuit board 30. The plurality of circuit parts 32 are electrically interconnected via electrical connections on the circuit board 30.

FIG. 7 is a plan view schematically showing the construction of a circuit board 30 in which a plurality of circuit parts 32 are disposed in a matrix shape. FIG. 8 is a diagram schematically showing a cross section of the display device 100 at position A-A′ in FIG. 7.

As shown in FIG. 7 and FIG. 8, on the circuit board 30, a plurality of circuit parts 32 including circuit parts 32a, 32b, and 32c are disposed in a matrix shape, in so-called “island” portions. In the portions of the circuit board 30 where the circuit parts 32 are not provided, a plurality of lines f of bending linearly extend through gaps (the “sea” portion) between the circuit boards 32, so that the circuit board 30 can be bent at the lines f of bending, whereby the flexibility of the display device 100 is further enhanced.

Based on the aforementioned concept, those circuit parts 32 which are longer along the X direction are formed with a small thickness, whereas those circuit parts 32 which are shorter along the X direction are formed with a large thickness, whereby a high flexibility is attained while keeping a small thickness of the housing 20. Since the circuit board 30 flexes while each circuit part 32 maintains its rigid state, it is possible to curve the housing 20 while keeping the housing 20 thin.

Next, a production method for the display device 100 will be described with reference to FIGS. 1 and 2.

In the production of the display device 100, first, a circuit part 32 having rigidity, a housing 20 internally having an upper face 20a and a bottom face 20b, and a display panel 10 are prepared (first step), and the circuit parts 32 are placed on the circuit board 30 (second step). Thereafter, the circuit board 30 is placed on the bottom face 20b of the housing 20 (third step), and the display panel 10 is attached on the housing 20 (fourth step).

Note that, as described above, the display panel 10, the circuit board 30, and the housing 20 have flexibility at least along the Z direction.

At the first step, given a length 2a of the circuit part 32 along the X direction, a thickness b of the circuit part 32 along the Z direction, a distance d between the bottom face 20b and the upper face 20a of the housing 20, or between the bottom face 20b and the lower face 10b of the display panel 10, and a minimum radius of curvature r(r₁) of the bottom face 20b which is determined when the housing 20 is curved along the Z direction, the circuit part 32 and the housing 30 are selected in sizes that satisfy the relationship of eq. (1) above. The radius of curvature r is a radius of curvature of the bottom face 20b when the housing 20 is curved so that the upper face 20a of the housing 20 or the lower face 10b of the display panel 10 abuts with the circuit part 32.

When the radius of curvature r is set in a range greater than 1 mm but smaller than 200 mm, at the first step, a housing 10 whose distance d is in a range greater than 0.5 mm but smaller than 10 mm is prepared. This allows a display device 100 that is formed in a range from a thickness which will be considered as the thinnest (internal space thickness d=0.5 mm) to a thickness which will be considered as relatively thin (internal space thickness d=10 mm) by the user to be bent to the required minimum radius of curvature r.

When the radius of curvature r is set in a range greater than 5 mm but smaller than 60 mm, at the first step, a housing 20 whose distance d is in a range greater than 1 mm but smaller than 3 mm is prepared. This allows a display device 100 that is formed with a thickness which is relatively easily producible and which will be considered by the user as sufficiently thin (internal thickness d=1 to 3 mm) to be bent to the required minimum radius of curvature r.

The radius of curvature r may be defined as the radius of curvature which is required, when the housing 20 at the position of the circuit part 32 is curved to a maximum extent along the Z direction, of the bottom face 20b being in that position. In this case, when the radius of curvature r is set in a range greater than 1 mm but smaller than 30 mm, the distance d is set in a range greater than 0.5 mm but smaller than 3 mm. By selecting a distance d and a radius of curvature r in such ranges, it becomes possible to further enhance the flexibility of the entire device, including the “island” portion containing the rigid circuit part 32. As a result, an appropriate flexibility which is adapted to the device size can be obtained, and the display device 100 made thinner can have a further enhanced flexibility.

According to a production method of a display device of the present invention, a flexible thin display device and thin electronic device with a reduced thickness, a reduced radius of curvature, and uniform flexibility (bending smoothly) across the entire device can be realized. The display device and electronic device produced by the production method of the present invention can prevent local bending, so that the stress of bending is prevented from localizing in specific portions of the housing, thus enhancing the reliability of the device. Moreover, since the device housing bends smoothly, an electronic device with excellent design aesthetic can be realized, and a more natural and human-friendly impression can be evoked in the user.

Next, a display device according to a second embodiment of the present invention will be described.

### Embodiment 2

FIG. 9 is a cross-sectional view schematically showing the construction of a display device 101 according to Embodiment 2. FIG. 10 is a cross-sectional view schematically showing a manner in which the display device 101 may be curved.

The display device 101 is a display device having flexibility, and as shown in FIG. 9 and FIG. 10, includes: a display panel 10 having flexibility; a housing 20 having flexibility; a circuit board 30 composed of a flexible printed board (FPC) or the like having flexibility; and a (rigid) circuit part 32 being disposed on the circuit board 30 and having rigidity. Furthermore, the display device 101 includes a battery 45 for supplying power to the circuit part 32 the battery 45 being disposed above the circuit board 30.

The battery 45 is a laminated battery, a paper battery of e.g. lithium ion polymer, or the like, which has flexibility. The battery 45 is disposed between the bottom face 20b of the housing 20 and the circuit board 30.

The display panel 10, the housing 20, and the circuit board 30 have flexibility at least along the Z direction. The housing 20 internally has an upper face 20a and a bottom face 20b, the circuit board 30 being disposed on an upper face 45a of the battery 45. The display panel 10 is disposed so that the upper face 10a thereof is in contact with the upper face 20a of the housing 20.

Assuming a length 2a of the circuit part 32 along the X direction, a thickness b (length along the Z direction) of the circuit part 32, a distance d between the bottom face 20b of the housing 20 (or the lower face of the battery 45) and the lower face 10b of the display panel 10 along the Z direction, and a radius of curvature r of the bottom face 20b of the housing 20 when the housing 20 is curved to a maximum extent along the Z direction, these values satisfy the following relationship, similarly to Embodiment 1.

a≦[d²−b²+2·r·(d−b)]^{(1/2)} (1)

Note that, in any portion of the display device 110 where the display panel 10 is not disposed, the upper part of the housing 20 is located at where the display panel 10 would be; therefore, in such portions, d represents the distance between the bottom face 20b of the housing 20 and the upper face 20a of the housing 20. The radius of curvature r is a radius of curvature of the bottom face 20b of the housing 20 when the housing 20 is curved so that the upper face 20a of the housing 20 or the lower face 10b of the display panel 10 abuts with the circuit part 32.

In the display device 101, too, effects similar to those of the display device 100 of Embodiment 1 are obtained because the relationship of the aforementioned inequality (1) is satisfied by the length 2a of the circuit part 32, the thickness b of the circuit part 32, the thickness d of the internal gap of the housing 20, and the radius of curvature r of the bottom face 20b of the housing 20 when the housing 20 is curved to a maximum extent. Although the battery 45 of the display device 101 spreads within the interior of the housing 20, the flexibility of the display device 101 can be sufficiently enhanced because the battery 45 has flexibility.

### INDUSTRIAL APPLICABILITY

The present invention is suitably used for display devices such as liquid crystal display devices having an active matrix substrate with thin film transistors, organic electro-luminescence (EL) display devices, and inorganic electro-luminescence display devices.

### REFERENCE SIGNS LIST

10 display panel
20 housing
30 circuit board
32 circuit part
35, 45 battery
100, 101 display device
200 flexible electronic device
211 flexible driver IC for driving
212 flexible display panel
213 flexible printed circuit
214 flexible driving circuit board
216 flexible case
217 flexible battery

1. A flexible display device, comprising:
a display panel having flexibility;
a circuit board having flexibility;
a circuit part disposed on the circuit board, the circuit part having rigidity; and
a housing accommodating the circuit board and supporting the display panel above the circuit board, the housing having flexibility, wherein,
the display panel, the circuit board, and the housing have flexibility at least along a first direction which is perpendicular to the plane of the display panel;
the housing internally has an upper face and a bottom face, the circuit board being disposed on the bottom face of the housing; and
a length 2a of the circuit part along a second direction which is parallel to the plane of the display panel, a thickness b of the circuit part along the first direction, a distance d between the bottom face and the upper face of the housing or between the bottom face and a lower face of the display panel, and a radius of curvature r of the bottom face of the housing when the housing is curved to a maximum extent along the first direction satisfy the relationship:
a≦[d²−b²+2·r·(d−b)]^{(1/2)}.

2. The flexible display device of claim 1, wherein the radius of curvature r is a radius of curvature of the bottom face of the housing when the housing is curved so that the upper face of the housing or the lower face of the display panel abuts with the circuit part.

3. The flexible display device of claim 1, wherein the distance d is in a range greater than 0.5 mm but smaller than 10 mm, and the radius of curvature r is in a range greater than 1 mm but smaller than 200 mm.

4. The flexible display device of claim 3, wherein the distance d is in a range greater than 1 mm but smaller than 3 mm, and the radius of curvature r is in a range greater than 5 mm but smaller than 60 mm.

5. The flexible display device of claim 1, wherein the radius of curvature r is a radius of curvature of the bottom face at the position of the circuit part when the housing at the circuit part of the position is curved to a maximum extent along the first direction.

6. The flexible display device of claim 5, wherein the distance d is in a range greater than 0.5 mm but smaller than 3 mm, and the radius of curvature r is in a range greater than 1 mm but smaller than 30 mm.

7. The flexible display device of claim 1, wherein the circuit part is a semiconductor chip, a semiconductor circuit board, a resistor, or a capacitor.

8. The flexible display device of any of claim 1, wherein the circuit board is a flexible printed board whose main component is polyimide.

9. The flexible display device of claim 1, wherein the display panel includes a pair of flexible substrates at least one of which is transparent, and liquid crystal sealed between the pair of flexible substrates, and performs displaying by altering an optical characteristic of the liquid crystal by applying an electric field across the liquid crystal.

10. The flexible display device of claim 1, comprising within the housing a battery for supplying power to the circuit part.

11. The flexible display device of claim 10, wherein the battery has flexibility.

12. A production method of a flexible display device, comprising:
a step of providing a circuit part having rigidity, a housing internally having an upper face and a bottom face, and a display panel;
a step of disposing the circuit part on a circuit board;
a step of disposing the circuit board on the bottom face of the housing; and
a step of disposing the display panel on the housing, wherein,
the display panel, the circuit board, and the housing have flexibility at least along a first direction which is perpendicular to the plane of the display panel; and
in the step of providing the circuit part, the housing, and the display panel, given a length 2a of the circuit part along a second direction which is parallel to the plane of the display panel, a thickness b of the circuit part along the first direction, a distance d between the bottom face and the upper face of the housing or between the bottom face and a lower face of the display panel, and a minimum radius of curvature r of the bottom face of the housing determined when the housing is curved along the first direction, the circuit part and the housing are selected in sizes satisfying the relationship:
a≦[d²−b²+2·r·(d−b)]^{(1/2)}.

13. The production method of a flexible display device of claim 12, wherein the radius of curvature r is a radius of curvature of the bottom face when the housing is curved so that the upper face of the housing or the lower face of the display panel abuts with the circuit part.

14. The production method of a flexible display device of claim of claim 12, wherein, when the radius of curvature r is in a range greater than 1 mm but smaller than 200 mm, in the step of providing the circuit part, the housing, and the display panel, a housing is provided such that the distance d is in a range greater than 0.5 mm but smaller than 10 mm.

15. The production method of a flexible display device of claim 14, wherein, when the radius of curvature r is in a range greater than 5 mm but smaller than 60 mm, in the step of providing the circuit part, the housing, and the display panel, a housing is provided such that the distance d is in a range greater than 1 mm but smaller than 3 mm.

16. The production method of a flexible display device of claim 12, wherein the radius of curvature r is a radius of curvature which is required of the bottom face at the position of the circuit part when the housing at the position of the circuit part is curved to a maximum extent along the first direction.

17. The production method of a flexible display device of claim 16, wherein, when the radius of curvature r is in a range greater than 1 mm but smaller than 30 mm, the distance d is set in a range greater than 0.5 mm but smaller than 3 mm.

18. The production method of a flexible display device of claim 12, wherein the circuit part is a semiconductor chip, a semiconductor circuit board, a resistor, or a capacitor.

19. The production method of a flexible display device of claim 12, wherein the display panel includes a pair of flexible substrates at least one of which is transparent, and liquid crystal sealed between the pair of flexible substrates, and performs displaying by altering an optical characteristic of the liquid crystal by applying an electric field across the liquid crystal.
